(19) United States
(12) Patent Application Publication
(10) Pub. No.: US 2022/0044116 A1
(43) Pub. Date: Feb. 10, 2022

(54) Computer-Implemented Method of Training a Computer-Implemented Deep Neural Network and Such a Network

(71) Applicant: NavInfo Europe B.V., Eindhoven (NL)

(72) Inventors: Elahe Arani, Eindhoven (NL); Fahad Sarfraz, Eindhoven (NL); Bahram Zonooz, Eindhoven (NL)

(21) Appl. No.: 17/382,121

(22) Filed: Jul. 21, 2021

(30) Foreign Application Priority Data
Jul. 30, 2020 (NL) 2026178
Sep. 17, 2020 (NL) 2026491

(51) Int. Cl. G06N 3/08; G06N 3/04; G06K 9/62

(52) U.S. Cl. CPC G06N 3/08; G06K 9/628; G06K 9/6256; G06N 3/0454

(57) ABSTRACT

A computer-implemented method of training a computer-implemented deep neural network with a dataset with annotated labels, wherein at least two models are concurrently trained collaboratively, and wherein each model is trained with a supervised learning loss, and a mimicry loss in addition to the supervised learning loss, wherein the super-vised learning loss relates to learning from environmental cues and supervision from the mimicry loss relates to imitation in cultural learning.

### CROSS-REFERENCE TO RELATED APPLICATIONS

This application claims priority to Netherlands Patent Application No. 2026178, filed on Jul. 30, 2020, and Netherlands Patent Application No. 2026491, filed on Sep. 17, 2020, and the specification and claims thereof are incorporated herein by reference.

### BACKGROUND OF THE INVENTION

### Field of the Invention

Embodiments of the present invention relate to a computer-implemented method of training a computer-implemented deep neural network with a dataset with annotated labels.

### Background Art

Deep neural networks (DNNs) have been shown to easily fit random labels [2] which makes it challenging to train the models efficiently. The majority of the prior art methods for training under label noise can be broadly categorized into two approaches: i) correcting the labels by estimating the noise transition matrix [3, 7], ii) identifying the noisy labels to either filter out [4, 8] or down-weight those samples [5, 6]. However, the former approach depends on accurately estimating the noise transition matrix which is difficult especially for a high number of classes, and the latter approach requires an efficient method for identifying noisy labels and/or an estimate of the percentage of noisy instances. Amongst these, there has been more focus on separating the noisy and clean instances where a common criterion is to consider low-loss instances as a proxy for clean labels [1, 4]. However, harder instances can be perceived as noisy and hence the model can be biased towards easy instances. Both approaches consider the annotations quality as the primary reason for the decrease in model's performance and hence the proposed solutions rely on accurately relabelling, filtering out or down-weighting instances with incorrect labels.

Contrary to the traditional approaches, instead of focusing on annotations, embodiments of the present invention focus on making the underlying training framework more robust to noisy labels. The lack of robustness of the known training procedure can be attributed to a number of factors. The cross-entropy loss maximizes a bound on the mutual information between one-hot encoded labels and a learned representation. The model being trained receives no information about the similarity of a data point among the classes and hence when the provided label is incorrect, it has no source of useful information about the instance or extra supervision to mitigate the adverse effect of a noisy label. There is also a lack of regularization to discourage the model from memorizing the training labels.

### BRIEF SUMMARY OF THE INVENTION

In order to at least in part address the aforementioned shortcomings in the training of neural networks, according to the computer-implemented method of an embodiment of the present invention, at least two models are concurrently trained collaboratively, wherein each model is trained with a supervised learning loss, and a mimicry loss in addition to the supervised learning loss, wherein the supervised learning loss relates to learning from groundtruth labels and the supervision from the mimicry loss relates to aligning the output of the two models.

Accordingly, each model, in addition to a supervised learning loss, is trained with a mimicry loss that aligns the posterior distributions of the two models for building consensus on the secondary class probabilities as well as the primary class prediction. The computer-implemented method of the invention is referred to as noisy concurrent training (NCT).

It is advantageous that the two models are initialized differently.

Specifically, NCT involves training models concurrently whereby each model is trained with a convex combination of a supervised learning loss and a mimicry loss. Even though the groundtruth labels (environmental cues) can be noisy, DNNs tend to prioritize learning simple patterns first before memorizing noisy labels, therefore in the initial phase of learning, emphasis in the training of the models is on using the supervised learning loss, therewith gradually increasing the fitness of the two models (population).

The initial phase of learning is followed by a phase wherein training progresses, and emphasis in the training of the models shifts to relying on the mimicry loss, wherein the relative weight of the supervised learning loss reduces. As training progresses, the information quality threshold is thus increased and the models can rely more on imitating each other and building consensus. This is simulated using a dynamic balancing scheme which progressively increases the weight of the mimicry loss while reducing the weight of the supervised learning loss. Accordingly, when training progresses the models build consensus on their accumulated knowledge and align their posterior probability distributions. The mimicry loss provides an extra supervision signal for training the models in addition to the one-hot labels which can enable the models to learn useful information even from training samples with incorrect labels.

Furthermore, to discourage memorization, it is preferable that during training the labels of a random fraction of samples taken in a batch from the dataset are changed to a random class sampled from a uniform distribution over the total number of classes for each batch independently for the at least two models. This technique is referred to as target variability and serves multiple purposes: it implicitly increases the information quality threshold by indicating to the models that it cannot rely too much on the noisy labels, acts as a strong deterrent to memorizing the training labels and also keeps the two models sufficiently diverged to avoid the confirmation bias arising from the method reducing to self-training.

Preferably the target variability is applied independently to each model so that the two networks remain sufficiently diverged so that collectively they can filter different types of errors.

Advantageously the target variability rate is initially low to allow the models to learn simple patterns effectively and increases progressively during the training to counter the tendency of the models for memorization.

The computer-implemented method of an embodiment of the present invention leads to a robust learning framework that allows efficient training of computer-implemented deep neural networks under substantial label noise levels. This significantly increases the applicability of the models in practical scenarios where annotations quality is often not perfect.

The computer-implemented method of an embodiment of the present invention enables the use of large scale automatically annotated and crowd-sourced datasets for learning rich representations which can be used for subsequent downstream tasks like segmentation, detection and depth estimation. The improved representations lead to performance gain in downstream tasks which have wide applications in various industries like self-driving cars and/or high-precision map creation.

Accordingly, embodiments of the present invention are also directed to a computer-implemented deep neural network provided with a dataset with annotated labels and with at least two models that are concurrently trained collaboratively, wherein each model is trained with a supervised learning loss, and a mimicry loss in addition to the supervised learning loss, wherein the supervised learning loss relates to learning from ground-truth labels and supervision from the mimicry loss relates to aligning the output of the two models.

The computer-implemented deep neural network according to the invention is preferably applied as backbone for one or more subsequent picture or video tasks selected from the group comprising segmentation, detection and depth estimation.

Furthermore, the computer-implemented deep neural network according to the invention is preferably embodied in a system for automatic driving and/or high-precision map updating.

Embodiments of the present invention will hereinafter be further elucidated with reference to an exemplary embodiment of a computer-implemented method according to the invention that is not limiting as to the appended claims. Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 schematically shows the concurrent training of the two models in a collaborative manner.

### DETAILED DESCRIPTION OF THE INVENTION

Given a dataset of N samples, D={x(i), y(i)} for i=1 to N, where x(i) is the input image and y(i) is the one-hot ground-truth label over C classes which can be noisy, the computer-implemented method of the invention, NCT, is formulated as dynamic collaboration learning between a cohort of two networks parametrized by θ1 and θ2. Each network is trained with a supervised loss (standard cross-entropy, LCE) and a mimicry loss (Kullback-Leibler divergence, DKL). The overall loss for each model is as follows:

$$\begin{matrix}{ℒ}_{{θ}_{1}} = ( 1 - α ) {ℒ}_{CE} ( σ ( {z}_{{θ}_{1}} ) , y ) + {ατ}^{2} {D}_{KL} ( \frac{σ ( {z}_{{θ}_{2}} )}{τ} ‖ \frac{σ ( {z}_{{θ}_{1}} )}{τ} ) & ( 1 ) \\ {ℒ}_{{θ}_{2}} = ( 1 - α ) {ℒ}_{CE} ( σ ( {z}_{{θ}_{2}} ) , y ) + {ατ}^{2} {D}_{KL} ( \frac{σ ( {z}_{{θ}_{1}} )}{τ} ‖ \frac{σ ( {z}_{{θ}_{2}} )}{τ} ) & ( 2 )\end{matrix}$$

where σ is the softmax function, zₑ are the output logits and T is the temperature which is usually set to 1. Using a higher τ value produces a softer probability distribution over classes. The tuning parameter α∈[0, 1] controls the relative weightage between the two losses.

For inference, the average ensemble of the two models is used,

$${y}_{pred} = σ ( \frac{{z}_{{θ}_{1}} + {z}_{{θ}_{2}}}{2} ) \qquad ( 3 )$$

Dynamic Balancing

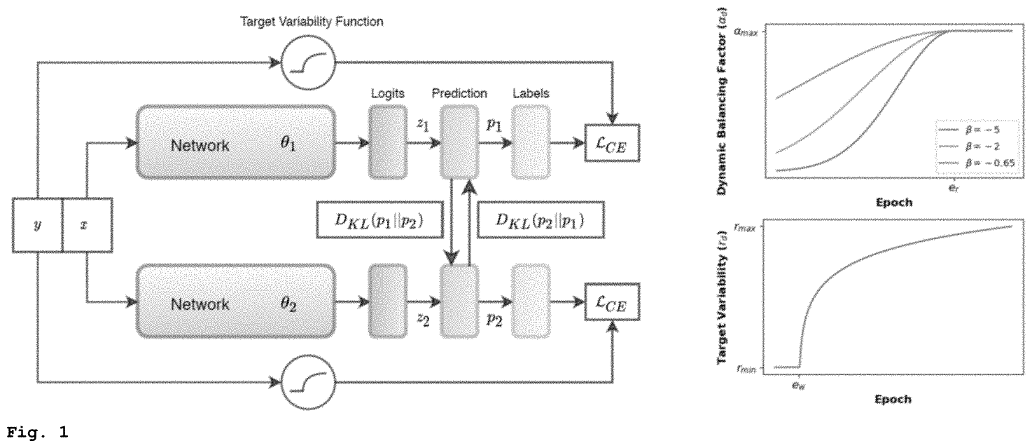

Given a mixture of clean and noisy labels, DNNs tend to prioritize learning simple patterns first and fit the clean data before memorizing the noisy labels [2]. NCT employs a dynamic balancing scheme whereby initially the two networks learn more from the supervision loss, i.e. smaller ad value, and as the training progresses, the networks focus more on building consensus and aligning their posterior distribution through DKL, i.e α_{d}→1. To simulate this behaviour, a sigmoid ramp-up function is used following [10],

$${α}_{d} = {α}_{max} exp ( - {β ( 1 - \frac{e}{{e}_{r}} )}^{2} ) \qquad ( 4 )$$

where αₘₐₓ is the maximum alpha value, e is the current epoch, eᵣ is the ramp-up length (the epoch at which ad reaches the maximum value) and β controls the shape of the function. FIG. 1 shows the dynamic balancing functions for different values of β.

Dynamic Target Variability

NCT uses target variability whereby for each sample in the training batch, with probability r, the one-hot labels are changed to a random class sampled from a uniform distribution over the number of classes C. Target variability acts as a regularizer and discourages the models from memorizing the labels. Target variability is applied independently to each model so that the two networks remain sufficiently diverged so that collectively they can filter different types of errors. As the networks tend to memorize the noisy labels in later stages of training, NCT employs dynamic target variability whereby the target variability rate is lower for initial epochs and increases progressively during the training (FIG. 1). NCT uses a logarithmic ramp-up function,

$${r}_{d} = \{ \begin{matrix}{r}_{min} , & if e \leq {e}_{w} \\ {r}_{min} + ( {r}_{max} - {r}_{min} ) \frac{log [ e - {e}_{w} ]}{log [ {e}_{max} - {e}_{w} ]} , & otherwise\end{matrix} \qquad ( 5 )$$

where rₘᵢₙ and rₘₐₓ are the minimum and maximum target variability rates, e is the current epoch, eₘₐₓ is the total number of epochs and e_{w} is the warmup length The details of the proposed computer-implemented method are summarized in Algorithms 1 and 2.

Algorithm 1 Noisy Co [symbol] Training Algorithem

| | |
|---|---|
| | Input: Dataset D, Number of calsses C. Temperature τ, Learning |
| | rate [symbol] Batch size [symbol] , Total epochs [symbol] Maximum |
| | target variability rate [symbol] Warmup length [symbol] . Maximum alpha |
| | value [symbol] . Ramp-up length [symbol] . Please shift β |
| | Initialize: M1 and M2 parameterized by [symbol] and [symbol] |
| 1: | while Not Converged do |
| 2: | Sample a (mini-batch [symbol] . . ., ( [symbol] ) ~ D |
| 3: | Compute the dynamic balancing factor [symbol] based on Eq. 4 |
| 4: | Compute the target variability rate [symbol] based on Eq. 5 |
| 5: | Get the new targets [symbol] = TARGET..VARIABILITY... |
| | FUNCTION [symbol] C) (Algorithm 2) |
| 6: | Compute the loss functions for both M1 and M2 models |
| | ${ℒ}_{{θ}_{1}} = ( 1 - \text{?} ) {ℒ}_{CE} ( \text{?} ( \frac{\text{?} ( \text{?} )}{\text{?}} )$ |
| | ${ℒ}_{{θ}_{1}} = ( 1 - \text{?} ) ℒ {CE}_{} ( \text{?} ( \frac{\text{?} ( \text{?} )}{\text{?}} )$ |
| 7 | Compute [symbol] gradients and update the parameters: |
| | $\text{?} ← \text{?} - \text{?} \frac{\text{?}}{\text{?}} \qquad$ |
| | $\text{?} ← \text{?} - \text{?} \frac{\text{?}}{\text{?}}$ |
| | return [symbol] [symbol] |

[symbol]

indicates data missing or illegible when filed

Algorithm 2 TARGET_VARIABILITY_FUNCTION

```
  Input: Labels y, mini-batch size b. Number of classes
  C, Target variability rate r_{d}
1: For i ∈ [1,2] do
2:  Create the noise masks:
        m = [mⱼ ~ [symbol]  (0,1)]^{b} < r_{d}
3:  Sample the random targets:
        yᵢ = [lⱼ ~ [symbol]  (0, C − 1)|lⱼ ≠ yⱼ]^{b}
4:  Apply target variability and create the new targets:
        ŷᵢ = m ⊙ yᵢ + (1 − m) ⊙ y
5: return ŷ₁ and ÿ₂
```

Results

In the following NCT is compared with multiple baseline computer-implemented methods under similar experimental setup. Since the quality of the dataset is not known a priori, the learning method should be general to work in both noisy as well as clean datasets. For this reason, we compare our method on both clean and various levels of label noise. Table 1 shows consistent improvement for lower noise levels. On clean CIFAR-100, the gap between M-Correction and NCT is considerable. However, the computer-implemented method of the invention is less optimal compared to MCorrection for very high levels of symmetric noise (50%).

Table 2 shows that the effectiveness of the computer-implemented method of the invention generalizes beyond CIFAR datasets to the complicated Tiny-ImageNet classification task. On symmetric noise, a similar pattern is shown as on CIFAR datasets. For asymmetric noise, which perhaps better simulates real-world noise, NCT provides a significant improvement in generalization. M-Correction shows an unstable behaviour on asymmetric noise, indicated by the high standard deviation in performance.

To verify the practical usage of NCT, the method is further compared on two real-world noisy datasets. Table 3 shows that NCT provides a considerable performance gain (ca. 10% increase in top1 accuracy) over the prior art methods on the WebVision dataset. For Clothing1M, Table 4 provides marginal gain over P-correction.

The empirical results on both clean and noisy versions of benchmark datasets as well as consistent improvement on real-world noisy datasets demonstrate the effectiveness of NCT as a general-purpose learning framework that is robust to label noise.

TABLE 1
Comparison with prior methods on CIFAR-10 and CIFAR-100 datasets with
symmetric noise. The results for baselines are copied from Arazo et al. [1] and following them, the
computer-implemented method of the invention shows the highest test accuracy (%) across all epochs
(Best) and the final epoch accuracy (Last). For the computer-implemented method of the invention, we
report the average and 1 STD of three different seed values.

| Dataset | | CIFAR-10 | | | CIFAR-100 | | |
|---|---|---|---|---|---|---|---|
| Alg./Noise (%) | | 0 | 20 | 50 | 0 | 20 | 50 |
| Standard | Best | 93.8 | 89.7 | 84.8 | 75.2 | 62.8 | 48.0 |
| | Last | 93.7 | 81.8 | 55.9 | 75.1 | 62.7 | 40.8 |
| Bootstrap [ [symbol] ] | Best | 94.7 | 86.8 | 79.8 | 76.1 | 62.1 | 46.6 |
| | Last | 94.6 | 82.9 | 58.4 | 75.9 | 62.0 | 37.9 |
| F-correction [ [symbol] ] | Best | 94.7 | 86.8 | 79.8 | 75.4 | 61.5 | 46.6 |
| | Last | 94.6 | 83.1 | 59.4 | 75.2 | 61.4 | 37.3 |
| Mixup [ [symbol] ] | Best | 95.3 | 95.6 | 87.1 | 74.8 | 67.8 | 57.3 |
| | Last | 95.2 | 92.3 | 77.6 | 74.4 | 66.0 | 46.6 |
| M-correction [ [symbol] ] | Best | 93.6 | 94.0 | 92.0 | 73.3 | 73.9 | 66.1 |
| | Last | 93.4 | 93.8 | 91.9 | 71.3 | 73.4 | 65.4 |
| NCT | Best | 95.6 ± 0.1 | 94.4 ± 0.1 | 90.7 ± 0.3 | 80.1 ± 0.1 | 74.4 ± 0.2 | 53.4 ± 0.3 |
| | Last | 95.5 ± 0.1 | 94.3 ± 0.0 | 89.7 ± 0.3 | 80.0 ± 0.2 | 74.1 ± 0.1 | 52.3 ± 0.7 |

TABLE 2
Comparison with prior methods on Tiny-ImageNet dataset with symmetric and
asymmetric pair flip noise. The results for baselines are copied from Yu et al. [8] and following them, the
computer-implemented method of the invention shows the highest (Best) and the average (Avg.) test
accuracy (%) over the last 10 epochs. For a fair comparison, the M-Correction is run on the noise
simulation in [8] using their public code and hyperparameters mentioned in their paper. We also run
Standard and Co-teaching+ on clean dataset. For all these experiments performed, we report the mean
and 1 STD of three different seed values.

| Noise Type | Symmetric | | | | | | Asymmetric | |
|---|---|---|---|---|---|---|---|---|
| Noise (%) | 0 | | 20 | | 50 | | 45 | |
| Alg. | Best | Avg. | Best | Avg. | Best | Avg. | Best | Avg. |
| Standard | 57.4 ± 0.5 | 56.7 ± 0.5 | 35.8 | 35.6 | 19.8 | 19.6 | 26.32 | 26.2 |
| Decoupling [ [symbol] ] | — | — | 37.0 | 36.3 | 22.8 | 22.6 | 26.61 | 26.1 |
| F-correction [ [symbol] ] | — | — | 44.5 | 44.4 | 33.1 | 32.8 | 0.67 | 0.6 |
| MentorNet [ [symbol] ] | — | — | 45.7 | 45.5 | 35.8 | 35.5 | 26.61 | 26.2 |
| Co-teaching+ [ [symbol] ] | 52.4 ± 0.2 | 52.1 ± 0.2 | 48.2 | 47.7 | 41.8 | 41.2 | 26.87 | 26.5 |
| M-correction [ [symbol] ] | 57.7 ± 0.3 | 57.2 ± 0.4 | 57.2 ± 0.5 | 56.6 ± 0.4 | 51.6 ± 0.3 | 51.3 ± 0.3 | 24.8 ± 10.0 | 24.1 ± 10.3 |
| NCT | 62.4 ± 0.5 | 61.5 ± 0.2 | 58.0 ± 0.2 | 57.2 ± 0.3 | 47.8 ± 0.1 | 47.4 ± 0.2 | 43.0 ± 0.2 | 42.4 ± 0.1 |

TABLE 3
Comparison with prior methods trained on WebVision dataset.
The results for baselines are copied from Chen et al. [14]
and following them, we report the final accuracy (%) on
the WebVision and ImageNet ILSVRC12 validation sets. For
the computer-implemented method of the invention, we report
the mean and 1 STD of three different seed values.

| | |
|---|---|
| WebVision | ILSVRC12 |

| Alg./Dataset | top1 | top5 | top1 | top5 |
|---|---|---|---|---|
| F-correction [ [symbol] ] | 61.12 | 82.68 | 57.36 | 82.36 |
| Decoupling [ [symbol] ] | 62.54 | 84.74 | 58.26 | 82.26 |
| D2L [ [symbol] ] | 62.68 | 84.00 | 57.80 | 81.36 |
| MentorNet [ [symbol] ] | 63.00 | 81.40 | 57.80 | 79.92 |
| Co-teaching [ [symbol] ] | 63.58 | 85.20 | 61.48 | 84.70 |
| Iterative-CV [ [symbol] ] | 65.24 | 85.34 | 61.60 | 84.98 |
| NCT | 75.16 | 90.77 | 71.73 | 91.61 |
| | ±0.34 | ±0.27 | ±0.44 | ±0.22 |

[symbol]

indicates data missing or illegible when filed

TABLE 4
Comparison with prior methods on Clothing1M. The results
for baselines are copied from original papers and following
them, we report the best test accuracy (%). For the computer-
implemented method of the invention, we report the mean
and 1 STD of three different seed values.

| Alg. | Test Accuracy |
|---|---|
| Standard | 68.94 |
| F-correction [ [symbol] ] | 69.84 |
| Joint-Optim [ [symbol] ] | 72.16 |
| M-correction [ [symbol] ] | 71.00 |
| Meta-Cleaner [ [symbol] ] | 72.50 |
| Meta-Learning [ [symbol] ] | 73.47 |
| P-correction [ [symbol] ] | 73.49 |
| NCT | 74.02 ± 0.08 |

[symbol]

indicates data missing or illegible when filed

TABLE 5
Effect of target variability rate parameter, rmax, on CIFAR-
10. We report the highest test accuracy (%) across all epochs
(Best) and the final epoch accuracy (Last). The mean and
1 STD of three different seed values are reported.

Symmetric (%)

| | | |
|---|---|---|
| rₘₐₓ | 20 | 50 |

| | | | |
|---|---|---|---|
| 0.0 | Best | 94.25 ± 0.12 | 85.37 ± 0.27 |
| | Last | 93.94 ± 0.15 | 79.60 ± 0.17 |
| 0.1 | Best | 94.26 ± 0.09 | 86.56 ± 0.20 |
| | Last | 94.08 ± 0.08 | 81.00 ± 0.23 |
| 0.3 | Best | 94.40 ± 0.07 | 89.35 ± 0.29 |
| | Last | 94.25 ± 0.03 | 86.83 ± 0.32 |
| 0.5 | Best | 94.25 ± 0.12 | 90.70 ± 0.28 |
| | Last | 94.19 ± 0.09 | 89.74 ± 0.29 |
| 0.7 | Best | 93.33 ± 0.08 | 89.69 ± 0.07 |
| | Last | 93.21 ± 0.02 | 89.48 ± 0.25 |
| 0.9 | Best | 88.20 ± 0.24 | 82.88 ± 0.36 |
| | Last | 87.05 ± 0.13 | 72.23 ± 0.27 |

Effect of Target Variability

In order to analyze the sensitivity of the computer-implemented method of the invention to the target variability parameters, the CIFAR-10 dataset is used with the same experimental setup as for the experiments above. The experiments show the effect of changing the rₘₐₓ value while keeping all other parameters fixed. Table 5 shows that target variability provides significant performance gain compared to the baseline NCT method without target variability (rₘₐₓ=0). Generally, for a wide range of target variability rates, 0.3≤rₘₐₓ≤0.7, NCT is not very sensitive to the choice of rₘₐₓ value. The method is more sensitive to the rₘₐₓ value for higher noise levels (50%) compared to the lower noise levels (20%).

Optionally, embodiments of the present invention can include a general or specific purpose computer or distributed system programmed with computer software implementing steps described above, which computer software may be in any appropriate computer language, including but not limited to C++, FORTRAN, BASIC, Java, Python, Linux, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices.

Although the invention has been discussed in the foregoing with reference to an exemplary embodiment of the computer-implemented method of the invention, the invention is not restricted to this particular embodiment which can be varied in many ways without departing from the invention. The discussed exemplary embodiment shall therefore not be used to construe the appended claims strictly in accordance therewith. On the contrary the embodiment is merely intended to explain the wording of the appended claims without intent to limit the claims to this exemplary embodiment. The scope of protection of the invention shall therefore be construed in accordance with the appended claims only, wherein a possible ambiguity in the wording of the claims shall be resolved using this exemplary embodiment.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

### REFERENCES

[1] Eric Arazo, Diego Ortego, Paul Albert, Noel E O'Connor, and Kevin McGuinness. Unsupervised label noise modelling and loss correction. arXiv preprint arXiv:1904.11238, 2019.
[2] Devansh Arpit, Stanisław Jastr ̨ebski, Nicolas Ballas, David Krueger, Emmanuel Bengio, Maxinder S Kanwal, Tegan Maharaj, Asja Fischer, Aaron Courville, Yoshua Bengio, et al. A closer look at memorization in deep networks. In Proceedings of the 34th International Conference on Machine Learning-Volume 70, pages 233-242. JMLR. org, 2017.
[3] Jacob Goldberger and Ehud Ben-Reuven. Training deep neural-networks using a noise adaptation layer. 2016.
[4] Bo Han, Quanming Yao, Xingrui Yu, Gang Niu, Miao Xu, Weihua Hu, Ivor Tsang, and Masashi Sugiyama. Coteaching: Robust training of deep neural networks with extremely noisy labels. In Advances in neural information processing systems, pages 8527-8537, 2018.
[5] Lu Jiang, Zhengyuan Zhou, Thomas Leung, Li-Jia Li, and Li Fei-Fei. Mentornet: Learning data-driven curriculum for very deep neural networks on corrupted labels. arXiv preprint arXiv:1712.05055, 2017.
[6] Eran Malach and Shai Shalev-Shwartz. Decoupling “when to update” from “how to update”. In Advances in Neural Information Processing Systems, pages 960-970, 2017.
[7] Giorgio Patrini, Alessandro Rozza, Aditya Menon, Richard Nock, and Lizhen Qu. Making neural networks robust to label noise: a loss correction approach. stat, 1050:13, 2016.
[8] Xingrui Yu, Bo Han, Jiangchao Yao, Gang Niu, Ivor W Tsang, and Masashi Sugiyama. How does disagreement help generalization against label corruption? arXiv preprint arXiv:1901.04215, 2019.
[9] Robert Boyd, Peter J Richerson, and Joseph Henrich. The cultural niche: Why social learning is essential for human adaptation. Proceedings of the National Academy of Sciences, 108 (Supplement 2):10918-10925, 2011.
[10] Samuli Laine and Timo Aila. Temporal ensembling for semi-supervised learning. arXiv preprint arXiv:1610.02242, 2016.
[11] Hongyi Zhang, Moustapha Cisse, Yann N Dauphin, and David Lopez-Paz. mixup: Beyond empirical risk minimization. arXiv preprint arXiv:1710.09412, 2017.
[12] Scott Reed, Honglak Lee, Dragomir Anguelov, Christian Szegedy, Dumitru Erhan, and Andrew Rabinovich. Train-ing deep neural networks on noisy labels with bootstrapping. arXiv pre-print arXiv:1412.6596, 2014.
[13] Xingjun Ma, Yisen Wang, Michael E Houle, Shuo Zhou, Sarah M Erfani, Shu-Tao Xia, Sudanthi Wijewickrema, and James Bai-ley. Dimensionality-driven learning with noisy la-bels. arXiv preprint arXiv:1806.02612, 2018.
[14] Pengfei Chen, Benben Liao, Guangyong Chen, and Shengyu Zhang. Understanding and utilizing deep neural networks trained with noisy labels. arXiv preprint arXiv:1905.05040, 2019.
[15] Daiki Tanaka, Daiki Ikami, Toshihiko Yamasaki, and Kiyoharu Aizawa. Joint optimization framework for learning with noisy labels. In Proceedings of the IEEE Conference on Computer Vision and Pattern Recognition, pages 5552-5560, 2018.
[16] Weihe Zhang, Yali Wang, and Yu Qiao. Metacleaner: Learn-ing to hallucinate clean representations for noisy-labeled visual recognition. In Proceedings of the IEEE Conference on Computer Vision and Pattern Recognition, pages 7373-7382, 2019.
[17] Junnan Li, Yongkang Wong, Qi Zhao, and Mohan S Kankanha-li. Learning to learn from noisy labeled data. In Proceedings of the IEEE Conference on Computer Vision and Pattern Recognition, pages 5051-5059, 2019.
[18] Kun Yi and Jianxin Wu. Probabilistic end-to-end noise correction for learning with noisy labels. In Proceedings of the IEEE Conference on Computer Vision and Pattern Recognition, pages 7017-7025, 2019.
[20] Ying Zhang, Tao Xiang, Timothy M Hospedales, and Huchuan Lu. Deep mutual learning. In Proceedings of the IEEE Conference on Computer Vision and Pattern Recognition, pages 4320-4328, 2018.
[21] Geoffrey Hinton, Oriol Vinyals, and Jeff Dean. Distilling the knowledge in a neural network. arXiv preprint arXiv:1503.02531, 2015.

What is claimed is:

1. A computer-implemented method of training a computer-implemented deep neural network with a dataset with annotated labels, wherein at least two models are concurrently trained collaboratively, wherein each model is trained with a supervised learning loss, and a mimicry loss in addition to the supervised learning loss, wherein the supervised learning loss relates to learning from ground-truth labels and supervision from the mimicry loss relates to aligning the output of the two models.

2. The computer-implemented method of claim 1, wherein the two models are initialized differently.

3. The computer-implemented method of claim 1, wherein each model is trained with a convex combination of the supervised learning loss and the mimicry loss.

4. The computer-implemented method of claim 1, wherein an initial phase of learning is defined wherein emphasis in the training of the models is on using the supervised learning loss and aimed at a smaller ad value according to the formula
$${α}_{d} = {α}_{max} exp ( - {β ( 1 - \frac{e}{{e}_{r}} )}^{2} ) \qquad ( 4 )$$
where αₘₐₓ is a maximum alpha value, e is a current epoch, eᵣ is a ramp-up length (i.e. the epoch at which ad reaches the maximum value) and β controls the shape of the function, therewith gradually increasing the fitness of the two models.

5. The computer-implemented method of claim 4, wherein an initial phase of learning is followed by a phase wherein training progresses and the emphasis in the training of the models shifts in that the relative weight of the supervised learning loss reduces while the relative weight of the mimicry loss increases.

6. The computer-implemented method of claim 4, wherein the initial phase of learning is followed by a phase wherein training progresses and the models build consensus on their accumulated knowledge wherein, in comparison with the initial phase, the networks increasingly rely on the mimicry loss to align their posterior probability distributions and lesser on fitting the ground-truth labels through the supervised loss.

7. The computer-implemented method of claim 1, wherein target variability is used wherein during training the labels of a random fraction of samples taken in a batch from the dataset are changed to a random class sampled from a uniform distribution over the total number of classes for each batch independently for the at least two models so as to discourage the models from memorizing the noisy training labels while at the same time keeping the at least two models diverged.

8. The computer-implemented method of claim 7, wherein target variability is applied independently to each model so that the two networks remain sufficiently diverged so that collectively they can filter different types of errors.

9. The computer-implemented method of claim 7, wherein the target variability rate is initially low to allow the models to learn simple patterns effectively and increases progressively during the training to counter the tendency of the models for memorization.

10. A computer-implemented deep neural network provided with a dataset with annotated labels and with at least two models that are concurrently trained collaboratively, wherein each model is trained with a supervised learning loss, and a mimicry loss in addition to the supervised learning loss, wherein the supervised learning loss relates to learning from ground-truth labels and supervision from the mimicry loss relates to aligning the output of the two models.

11. The computer-implemented deep neural network according to claim 10, applied to downstream tasks, such as a backbone for one or more subsequent picture or video tasks selected from the group comprising computer vision tasks such as segmentation, detection and depth estimation.

12. The computer-implemented deep neural network according to claim 10, embodied in a system for automatic driving and/or high-precision map updating.
